(19) United States
(12) Patent Application Publication
(10) Pub. No.: US 2026/0195543 A1
(43) Pub. Date: Jul. 9, 2026

(54) OPTIMIZING PROMPTS FOR LARGE LANGUAGE MODELS

(71) Applicant: NTT DATA Americas, Inc., Plano, TX (US)

(72) Inventors: Gowrishanker Pari, Chennai (IN); Aananthanarayanan Pandian, Chennai (IN); Ilamparidhi Vasulingam, Chennai (IN); Dhurai Ganesan, Chennai (IN); Tanvir Khan, Allen, TX (US)

(21) Appl. No.: 19/015,474

(22) Filed: Jan. 9, 2025

(51) Int. Cl. G06F 40/40; G06F 18/241; G06N 3/0475

(52) U.S. Cl. CPC G06F 40/40; G06F 18/241; G06N 3/0475

(57) ABSTRACT

In an embodiment, a method includes receiving a first prompt for a large language model (LLM) and categorizing the first prompt into a category based on a topic modeling algorithm. The method also includes processing the first prompt to remove information determined to be irrelevant to the category. The method also includes retrieving one or more historical prompts for the LLM based on a determination that the one or more historical prompts are similar to the first prompt. The method also includes identifying, based on a feedback model, at least one historical prompt as producing an accurate response from the LLM. The method also includes generating a final prompt for the LLM based on the at least one historical prompt. The method also includes providing the final prompt to the LLM.

A user may provide an input, such as a question, to an artificial intelligence (AI) software application (e.g., a chatbot). The AI software application, in turn, may generate and provide an output, such as an answer to the question. Oftentimes, the output is inaccurate or incomplete with respect to an objective or intent of the user.

### SUMMARY

A system of one or more computers can be configured to perform particular operations or actions by virtue of having software, firmware, hardware, or a combination of them installed on the system that in operation causes or cause the system to perform the actions. One or more computer programs can be configured to perform particular operations or actions by virtue of including instructions that, when executed by data processing apparatus, cause the apparatus to perform the actions.

In one general aspect, in an embodiment, a method of optimizing utilization of large language models (LLMs) includes receiving a first prompt for an LLM. The method also includes categorizing the first prompt into a category based on a topic modeling algorithm. The method also includes processing the first prompt to remove information determined to be irrelevant to the category. The method also includes retrieving one or more historical prompts for the LLM based on a determination that the one or more historical prompts are similar to the first prompt. The method also includes identifying, based on a feedback model, at least one historical prompt of the one or more historical prompts as producing an accurate response from the LLM. The method also includes generating a final prompt for the LLM based on the at least one historical prompt. The method also includes providing the final prompt to the LLM.

In another general aspect, in an embodiment, a system includes a processor and memory, where the processor and memory in combination are operable to implement a method of optimizing utilization of large language models (LLMs). The method includes receiving a first prompt for an LLM. The method also includes categorizing the first prompt into a category based on a topic modeling algorithm. The method also includes processing the first prompt to remove information determined to be irrelevant to the category. The method also includes retrieving one or more historical prompts for the LLM based on a determination that the one or more historical prompts are similar to the first prompt. The method also includes identifying, based on a feedback model, at least one historical prompt of the one or more historical prompts as producing an accurate response from the LLM. The method also includes generating a final prompt for the LLM based on the at least one historical prompt. The method also includes providing the final prompt to the LLM.

In another general aspect, in an embodiment, a computer-program product includes a non-transitory computer-usable medium having computer-readable program code embodied therein, the computer-readable program code adapted to be executed to implement a method of optimizing utilization of large language models (LLMs). The method includes receiving a first prompt for an LLM. The method also includes categorizing the first prompt into a category based on a topic modeling algorithm. The method also includes processing the first prompt to remove information determined to be irrelevant to the category. The method also includes retrieving one or more historical prompts for the LLM based on a determination that the one or more historical prompts are similar to the first prompt. The method also includes identifying, based on a feedback model, at least one historical prompt of the one or more historical prompts as producing an accurate response from the LLM. The method also includes generating a final prompt for the LLM based on the at least one historical prompt. The method also includes providing the final prompt to the LLM.

### BRIEF DESCRIPTION OF THE DRAWINGS

A more complete understanding of the method and apparatus of the present disclosure may be obtained by reference to the following Detailed Description when taken in conjunction with the accompanying Drawings wherein:

FIG. 1 illustrates an example computing environment for implementing a data processing system.

FIG. 2 illustrates an example of a prompt optimization system.

FIG. 3 illustrates an example of a process for optimizing utilization of large language models (LLMs).

FIG. 4 illustrates an example of prompt optimization according to the process of FIG. 3.

FIG. 5 illustrates another example of prompt optimization according to the process of FIG. 3.

FIG. 6 illustrates an example of a computer system.

### DETAILED DESCRIPTION

In certain embodiments of the present invention, data processing can occur via one or more machine learning (ML) algorithms or other algorithms that are applied to incoming data streams. In various cases, the data processing can involve performing particular tasks with respect to the incoming data streams. The particular tasks can involve, for example, predicting data, generating new data, performing configurable workflows, combinations of the foregoing and/or the like. ML can use various techniques to learn to perform the particular tasks, without being explicitly programmed for the tasks, in some cases using training data that is of a same format as the incoming data stream. In general, ML can encompass various types of algorithms such as, for example, decision tree learning, association rule learning, artificial neural networks (including deep learning and, in particular, feed forward networks), inductive logic programming, support vector machines, clustering, Bayesian networks, reinforcement learning, representation learning, similarity and metric learning, sparse dictionary learning, genetic algorithms, rule-based ML, gradient boosting, ML based on generalized linear modeling, random forest, ensemble learning, combinations of the foregoing and/or the like.

Further to the above, in certain embodiments, data processing can occur via third-party generative artificial intelligence (AI) software, such as chatbots, virtual assistants and/or the like. In general, the third-party generative AI software can operate based on large language models (LLMs). Examples of such third-party generative AI software include OPENAI CHATGPT, GOOGLE GEMINI, and MICROSOFT COPILOT.

In certain aspects, data processing via an LLM can be driven by input data, sometimes referred to herein as a “prompt,” that is provided to the LLM by a user. The user can be, for example, a human user, a robotic user or “bot,” any component of a computer system, or the like. The prompt may represent an objective of a user, such as an objective to obtain a complete answer to a question. When a prompt is provided to an LLM, the LLM typically generates and provides output data, sometimes referred to herein as a “response,” that is responsive to the input data.

Problematically, the output from the LLM may not be accurate or complete with respect to the objective of the user. In such cases, the user may execute further attempts to fulfill the objective, for example, by modifying the prompt and iterating output generation until a desired output is received from the LLM. In some aspects, the number of attempts can depend upon on the wording of the prompts that the user provides to the LLM. If the user's prompt is not suitable for the objective, the corresponding output from the LLM is unlikely to be suitable, thus leading to multiple iterations of output generation, which in turn impacts computer system

### Productivity and Output Accuracy.

Further to the above problems, LLMs commonly operate, for example, based on tokens. The higher the number of words of the prompt, the higher the number of tokens processed by the LLM. As the number of tokens increases, the computing cost involved to process each prompt also increases. Similarly, as the number of prompts increases (e.g., due to iterating output generation until a desired output is received, as discussed above), the overall computing cost of fulfilling the user's objective increases.

The present disclosure describes examples of optimizing input data for external models, such as prompts for LLMs that drive third-party generative AI software. In certain aspects, a prompt optimization system can process the prompts in a way that improves the effectiveness and efficiency of the LLMs. In some aspects, the prompt optimization system can utilize and/or include an ensemble of software engines to process the prompts. In some aspects, the prompt optimization system can serve as a gateway that intercepts and processes each prompt as the prompt flows from a requesting user to an LLM, such that the processed or optimized prompt is provided to the LLM instead of the original prompt provided by the requesting user.

Advantageously, in certain aspects, the prompt optimization system can enable faster and more effective utilization of LLMs, for example, as a result of fewer iterations of output generation before a desired output is achieved. In addition, or alternatively, the prompt optimization system can provide faster and more efficient utilization of LLMs, for example, as a result of fewer tokens being processed by the LLMs. In addition, or alternatively, the prompt optimization system can provide for simpler maintenance, for example, due to modularization provided by a configurable ensemble of software engines. Examples will be described relative to the Drawings.

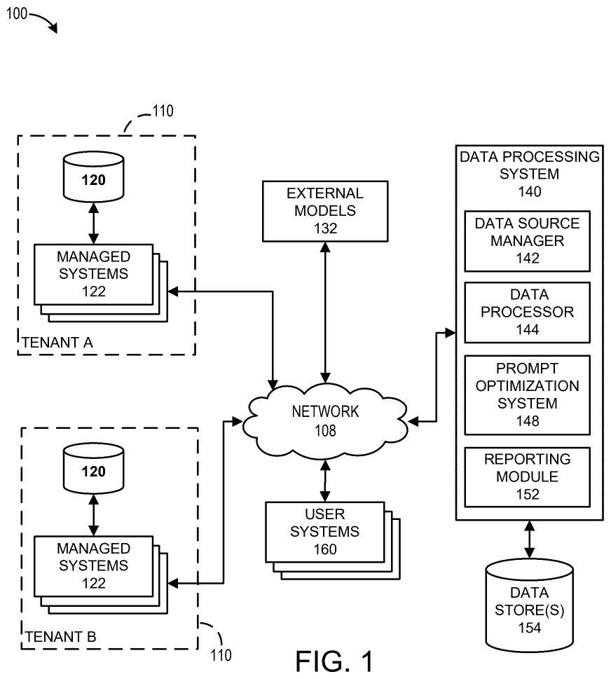

FIG. 1 illustrates an example computing environment 100 for implementing a data processing system 140. The computing environment 100 includes the data processing system 140, tenant systems 110, external models 132, user systems 160 and data store(s) 154, each of which is operable to communicate over a network 108. The network 108 may be a private network, a public network, a local or wide area network, a portion of the Internet, combinations of the same, and/or the like.

In certain embodiments, the data processing system 140 can centrally manage data processing of data sources for its tenants. In particular, in the computing environment 100, the tenant systems 110 can be served by the data processing system 140. The tenant systems 110 shown can be owned or operated by the same or different entities. For example, one of the tenant systems 110 is shown as owned or operated by “Tenant A” while another system 110 is owned or operated by a different tenant, “Tenant B.” The tenant systems 110 shown can be owned or operated by the same or different entities. For example, Tenants A and B can represent customers (e.g., entities such as companies or individuals) of an operator of the data processing system 140. Although the term “tenant” is used herein to describe the systems 110 or owners/operators thereof, in addition to having its ordinary meaning, the term “tenant” can, but need not, refer to tenancy in a multitenant software architecture.

More specifically, the tenant systems 110 can include one or more computer systems 122 that are each communicably coupled to, or include, one or more managed data sources 120. The one or more managed data sources 120 can include data streams or datasets that can be processed by the data processing system 140. In various cases, the one or more data sources 120 can be updated by the computer systems 122, or other components, in real-time, on a periodic basis, e.g., according to a schedule, on-demand or a combination of the same. Although the tenant systems 110 are shown as separate from each other and the data process system 140, in some aspects, each of the tenant systems 110 can be implemented on the data processing system 140.

In the illustrated embodiment, the data processing system 140 can include a data source manager 142, a data processor 144, a prompt optimization system 148, and a reporting module 152. Each of these components can be implemented with hardware and/or software, including (optionally) virtual machines or containers. In an example, the data processing system 140 can be implemented as a single management server. In another example, the data processing system 140 can be implemented in a plurality of virtual or physical servers, which may or may not be geographically co-located. In some embodiments, the data processing system 140 and/or other aspects of the computing environment 100 may be hosted on a cloud-provider system such as the Azure™ service provided by Microsoft® or the EC2™ platform provided by Amazon®.

In certain embodiments, features of the components of the data processing system 140 can be made accessible over an interface to the user systems 160. The user systems 160 can include any type of computing device, including computer systems such as desktops, laptops, tablets, smartphones, media devices, and wearable computers such as smartwatches or headsets, to name a few. The user systems 160 can be operated by users associated with the tenants or by other users.

The data source manager 142 can coordinate the managed data sources 120. In various embodiments, the data source manager 142 can identify, receive, pull, and/or communicate with the computer systems 122 so as to enable processing of the managed data sources 120. In some embodiments, the data source manager 142 can serve a data collection function. In these embodiments, the computer systems 122 can obtain or collect datasets in real-time, periodically, e.g., according to a schedule, on-demand, or a combination of the same. In some cases, such datasets can be provided as a live stream. In some cases, data from the managed data sources 120 can be collected and stored in the data store(s) 154. In other cases, the data can remain at the managed data sources 120.

The data processor 144 can process data according to a plurality of algorithms supported thereby (e.g., ML-based and/or rule-based algorithms), potentially using different configuration settings and/or algorithms for different data sources. The processing performed by the data processor 144 can involve executing particular tasks with respect to the data such as, for example, data prediction, generation of new data, execution of configurable workflows (e.g., processing medical claims), combinations of the foregoing and/or the like. Models representing the algorithms and/or the configuration settings for such algorithms can be stored, for example, in the data store(s) 154. In addition, or alternatively, the data processor 144 can facilitate data processing, for example, by the user systems 160. In some aspects, the data processor 144 can provide an interface to the user systems 160 for performing data processing.

In certain aspects, the data processor 144 and/or users of the user systems 160 can access the external models 132 to perform certain functions. The external models 132 can represent, for example, publicly available models that are accessible over the network 108. The external models 132 can include, for example, external LLMs that drive third-party generative AI software and/or other external models, as discussed previously.

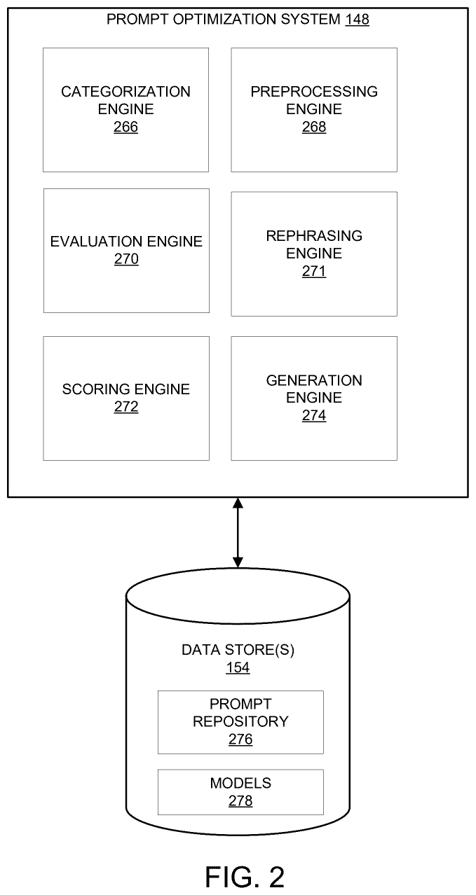

In certain aspects, the prompt optimization system 148 can process prompts in a way that improves the effectiveness and efficiency of the external models 132, such as LLMs. In some aspects, the prompt optimization system 148 can utilize and/or include an ensemble of software engines to process the prompts. In some aspects, the prompt optimization system 148 can serve as a gateway that intercepts and processes each prompt as the prompt flows from a requesting user to the external models 132, such that, for example, the processed or optimized prompt is provided to an LLM instead of the original prompt provided by the requesting user. An example of the prompt optimization system 148 will be described relative to FIGS. 2-5.

The reporting module 152 can generate regular or on-demand reports related to the data processor 144, the policy configurator 362, the prompt optimization system 148, and/or any other component of the computing environment 100. The reporting module 152 can publish reports or other generated information, for example, to a web page, dashboard, and/or the like. The reporting module 152 can also generate and execute a query of the data store(s) 154. The web page, user dashboard or other user interface(s) output, for example, by the reporting module 152, can be accessed by users of the user systems 160. The reporting module 152 can also provide a user interface, for instance, that allows the users of the user systems 160 to obtain customized data related to any data maintained by the data store(s) 154.

In general, the data store(s) 154 can include any information collected, stored, used, produced and/or output by the data processing system 140 or a component thereof. For example, in various embodiments, the data store(s) 154 can include a repository of historical prompts, ML models, ML frameworks, identification of ML models used for particular managed data sources of the managed data sources 120, software, training datasets, ML threat signatures, data collected or received from the managed data sources 120, data processed by the data processor 144, combinations of the same and/or the like. In certain embodiments, data stored in the data store(s) 154 can take the form of repositories, flat files, databases, etc. An example of the data store(s) 154 will be discussed relative to FIG. 2.

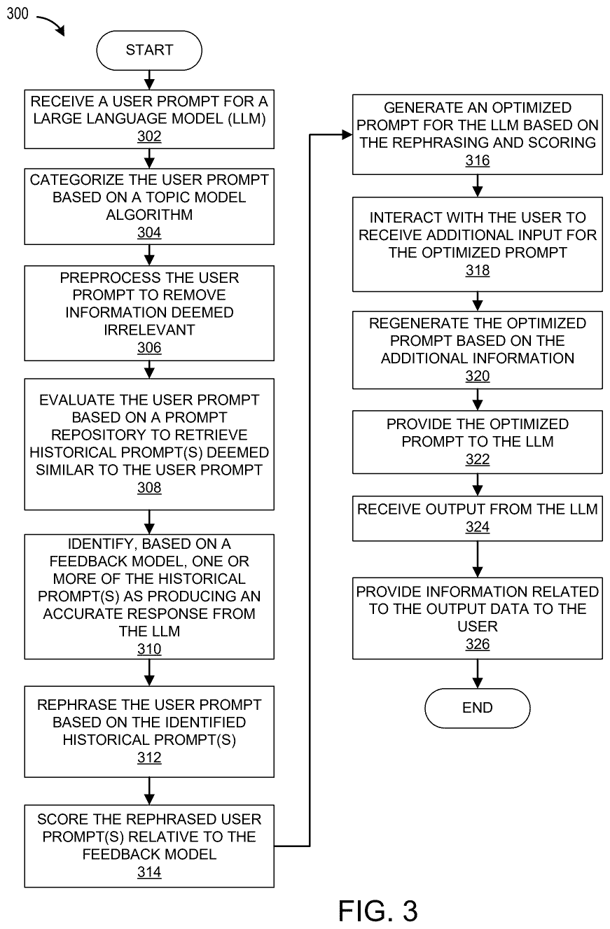

FIG. 2 illustrates an example of the prompt optimization system 148 in relation to the data store(s) 154. The prompt optimization system 148 is shown to include a categorization engine 266, a preprocessing engine 268, an evaluation engine 270, a scoring engine 272, a rephrasing engine 271, and a generation engine 274. In certain aspects, the prompt optimization system 148 can maintain, in the data store(s) 154, a prompt repository 276 and one or more models 278. Example operation of the components of the prompt optimization system 148 will be described relative to FIGS. 3-5.

FIG. 3 illustrates an example of a process 300 for optimizing utilization of LLMs via prompt optimization. In certain embodiments, the process 300 can be executed, for example, by the prompt optimization system 148 of FIGS. 1 and 2 and/or components thereof. The process 300 can also be executed generally by the data processing system 140 of FIG. 1. Although the process 300 can be executed by any number of different components, to simplify discussion, the process 300 will be described relative to the prompt optimization system 148 and components thereof.

At block 302, the prompt optimization system 148 receives a user prompt for an LLM. For example, in some aspects, the prompt optimization system 148 intercepts a prompt directed to an LLM represented in the external models 132 of FIG. 1. The user prompt may originate with (e.g., be input or provided by), for example, a human user, a robotic user, another system or software application, and/or the like. In some cases, the user prompt may originate with the data processor 144 of FIG. 1.

In certain aspects, blocks 304-320 relate to processing and optimizing the user prompt prior to its provision to the LLM. At block 304, the user prompt is categorized into one or more categories, for example, using the text of the user prompt. For example, the block 304 can include the prompt optimization system 148 sending the user prompt to the categorization engine 266 for categorization into the one or more categories. In certain aspects, the categorization engine 266 can identify the one or more categories using a topic modeling algorithm. In certain aspects, the topic modeling algorithm can extract the one or more categories from the user prompt using, for example, Latent Dirichlet Allocation (LDA), non-negative matrix factorization (NMF), and/or the like. In some aspects, the one or more categories can include, for example, a business domain, such as information technology service management (ITSM), application development, business process optimization (BPO), healthcare, finance, and/or the like.

At block 306, the user prompt is preprocessed to remove information deemed irrelevant, for example, to the one or more categories from the block 304. The removed information can include any text in the user prompt, such as words or characters. For example, the block 306 can include the prompt optimization system 148 sending the categorized user prompt (from the block 304) to the preprocessing engine 268. The preprocessing engine 268 can remove information deemed irrelevant, for example, using one or more ML and/or rule-based models. In some cases, different categories can be associated with different models. In various aspects, each model utilized at the block 306 can be included, for example, in the models 278 of FIG. 2. In this way, the irrelevant information can be removed with minimal impact to context or meaning within the user prompt. In addition, or alternatively, the preprocessing at the block 306 can include standardizing language of the user prompt (e.g., according to rules, ML models, or the like).

In an example, in some aspects, the preprocessing engine 268 can remove information deemed irrelevant by employing one or more models for feature extraction and/or summarization. According to this example, the categorized user prompt (from the block 304) can be input to the one or more models to produce an output. The output can be, for example, a set of extracted features (e.g., a vector representing selected aspects of the categorized user prompt, such as one or more words or phrases from the categorized user prompt), a condensed or summarized version of the categorized user prompt, and/or the like. Information not included in the output may be deemed irrelevant by virtue of its exclusion therefrom. In this way, the output can serve as the preprocessed user prompt yielded by the block 306. Other examples of preprocessing the user prompt to remove information will be apparent to one skilled in the art after a detailed review of the present disclosure.

At block 308, the user prompt is evaluated, for example, based on the prompt repository 276, to identify and retrieve one or more historical prompts that are deemed similar thereto. For example, the block 308 can include the prompt optimization system 148 sending the preprocessed user prompt (from the block 306) to the evaluation engine 270 for evaluation. In certain aspects, the evaluation engine 270 can identify the one or more historical prompts based on their textual similarity to the preprocessed user prompt.

For example, as part of the block 308, the evaluation engine 270 can match words or information from the preprocessed user prompt with words or information from each of the historical prompts in the prompt repository 276. In addition, or alternatively, the evaluation engine 270 can match the words or information from the preprocessed user prompt with words or information from each of the historical prompts in a configurable subset of the prompt repository 276, such as a subset associated with the one or more categories from the block 304. According to this example, the evaluation engine 270 can associate each of the historical prompts that are matched to the preprocessed user prompt with a confidence score indicative of a degree of match. In certain aspects, the evaluation engine 270 can compare each confidence score to a threshold. According to these aspects, the evaluation engine 270 can flag, or deem similar, any of the historical prompts associated with confidence scores in excess of the threshold, such that the similar historical prompt(s) are retrieved.

At block 310, one or more of the similar historical prompt(s) are identified as previously producing an accurate response from the LLM. In certain aspects, the block 310 can be performed, for example, by the evaluation engine 270. In certain aspects, the evaluation engine 270 can review the similar historical prompt(s) retrieved at the block 308, based on the prompt repository 276, using a feedback model. In some aspects, the feedback model identifies which prompts in the prompt repository 276 previously produced accurate responses from the LLM. In various aspects, the feedback model can be included, for example, in the models 278 of FIG. 2.

At block 312, the user prompt is rephrased based on the identified historical prompt(s) from the block 310. For example, the block 312 can include the prompt optimization system 148 sending the preprocessed user prompt from the block 306 to the rephrasing engine 271 for rephrasing. In some aspects, the rephrasing engine 271 rephrases the preprocessed user prompt based on the identified historical prompt(s), for example, by applying one or more techniques such as few-shot learning, prompt tuning, and/or the like.

In certain aspects, the rephrasing at the block 312 can include, for example, the rephrasing engine 271 inserting one or more placeholders for additional information not included in the preprocessed user prompt. Each placeholder can be, for example, a tag or other indicator of a further data element recommended for inclusion. In some aspects, the one or more placeholders can correspond to a data element that is included in at least one of the identified historical prompt(s) from the block 310 but that is not included in the preprocessed user prompt.

In various aspects, the rephrasing at the block 312 can yield a plurality of rephrased user prompts. For example, if the block 310 results in more than one historical prompt being identified, the block 312 can yield a rephrased user prompt for each identified historical prompt. According to these aspects, each rephrased user prompt can include, for example, one or more placeholders for additional information that are based on the corresponding historical prompt. In this way, different rephrased user prompts can include different phrasing, different placeholders, and/or the like.

At block 314, each rephrased user prompt yielded by the block 312 can be scored, for example, relative to the feedback model. In certain aspects, the block 314 can include the prompt optimization system 148 sending the rephrased user prompt(s) from the block 312 to the scoring engine 272 for scoring. For example, as part of the block 314, the scoring engine 272 can match words or information from each rephrased user prompt with words or information from each of the identified historical prompt(s) from the block 310. According to this example, the scoring engine 272 can associate each of the rephrased user prompts with a score indicative of a degree of match with at least one of the identified historical prompt(s). In various aspects, the score can correspond to the identified historical prompt having the greatest degree of match. In addition, or alternatively, the score can correspond to statistical aggregation of the degree of match with the identified historical prompt(s) (e.g., an arithmetic mean or the like). Other examples of scoring will be apparent to one skilled in the art after a detailed review of the present disclosure. In some aspects, if the block 312 yields only one rephrased user prompt, the block 314 can be omitted.

At block 316, an optimized user prompt for the LLM is generated based on the rephrasing at the 312 and the scoring at the block 316. In certain aspects, the block 316 can include the prompt optimization system 148 sending the rephrased user prompt(s) (from the block 312) and the corresponding score(s) (from the block 314) to the generation engine 274 for generation of the optimized user prompt. For example, as part of the block 316, the generation engine 274 can select the optimized user prompt from the rephrased user prompt(s). According to this example, the optimized user prompt can correspond to the rephrased user prompt having the highest score. In some aspects, the generation engine 274 can further refine the selected rephrased user prompt based on a suitable algorithm to form the optimized user prompt.

In some aspects, the optimized prompt can be a final prompt for the LLM. For example, if the optimized prompt does not include any placeholders for additional information, further processing and optimization can be omitted. In these aspects, the optimized prompt can correspond to the final prompt for the LLM and the process 300 can proceed directly, for example, to the block 322 (discussed further below). In other aspects, such as when the optimized prompt includes one or more placeholders for additional information, the process 300 can proceed to block 318 (as illustrated in FIG. 3).

At block 318, the prompt optimization system 138 interacts with the user to receive additional input for the optimized prompt. The additional input can correspond, for example, to the additional information indicated by the one or more placeholders discussed above. The block 318 can include, for example, publishing the optimized prompt to the user and requesting data corresponding to each of the one or more placeholders. In certain aspects, the block 318 can be performed, for example, by the generation engine 274.

At block 320, the optimized prompt is regenerated based on the additional input received at the block 318. For example, as part of the block 320, the generation engine 274 can regenerate the optimized prompt to include the received additional input in place of the one or more placeholders. In certain aspects, the regenerated optimized prompt can correspond to a final prompt for the LLM.

At block 322, the optimized prompt (e.g., as generated at the block 316 or as regenerated at the block 320) is provided to the LLM. In this way, the optimized prompt provided at the block 322 serves as the final prompt for the LLM following processing and optimization at blocks 304-320, as applicable.

At block 324, the prompt optimization system 148 receives an output from the LLM. In some aspects, the output can be intercepted by the prompt optimization system 148 and processed (e.g., filtered) thereby. The output can include, for example, a response to the optimized prompt provided at the block 322. At block 326, the prompt optimization system 148 provides information related to the output to the user. For example, in some aspects, the prompt optimization system 148 can publish the output, or a processed version of the output produced by the prompt optimization system 148, to the user. In addition, or alternatively, the prompt optimization system 148 can provide a location of the output (e.g., link or other indicator of where the output is available). After block 326, the process 300 ends.

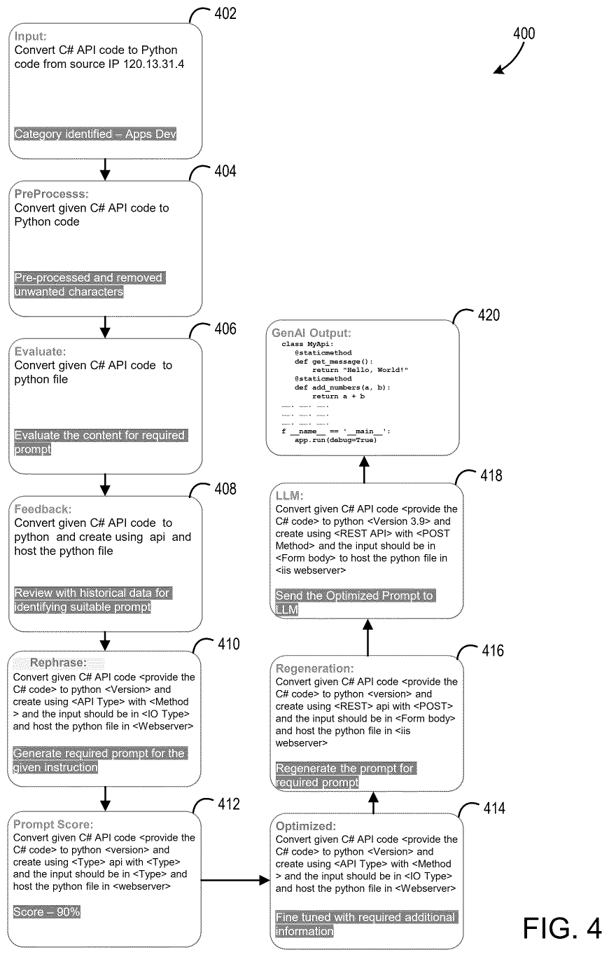

FIG. 4 illustrates an example 400 of prompt optimization for application development, for example, according to the process 300 of FIG. 3. Block 402 illustrates an example of a user prompt that is received and categorized as discussed, for example, with respect to blocks 302 and 304, respectively, of FIG. 3. In the example 400, the user prompt is categorized into application development.

In the example 400, block 404 illustrates an example of a preprocessed user prompt as discussed, for example, with respect to block 306 of FIG. 3. In the example 400, the preprocessed user prompt excludes information deemed irrelevant to the category and/or prompt, such as a source internet protocol (IP) address. Further, in the example 400, the preprocessed user prompt standardizes the language of the user prompt, for example, by adding the term “given.”

In the example 400, block 406 illustrates an example evaluation of the preprocessed user prompt by the evaluation engine 270, for example, as discussed relative to block 308 of FIG. 3. For illustrative purposes, the block 406 illustrates retrieval of one historical prompt.

In the example 400, block 408 illustrates an example of identifying a historical prompt that previously produced an accurate response as discussed, for example, with respect to block 310 of FIG. 3.

In the example 400, block 410 illustrates an example of a rephrased user prompt as discussed, for example, with respect to block 312 of FIG. 3.

In the example 400, block 412 illustrates an example scoring of the rephrased user prompt as discussed, for example, with respect to block 314 of FIG. 3.

In the example 400, block 414 illustrates an example of an optimized prompt as discussed, for example, with respect to block 316 of FIG. 3

In the example 400, block 416 illustrates an example of a regenerated optimized prompt as discussed, for example, with respect to block 320 of FIG. 3. In certain aspects, the regenerated optimized prompt can follow user interaction as discussed, for example, relative to block 318 of FIG. 3.

In the example 400, block 418 illustrates an example of a final prompt being provided to an LLM as discussed, for example, with respect to block 322 of FIG. 3.

In the example 400, block 420 illustrates an example of an output from the LLM as discussed, for example, with respect to blocks 324 and 326 of FIG. 3.

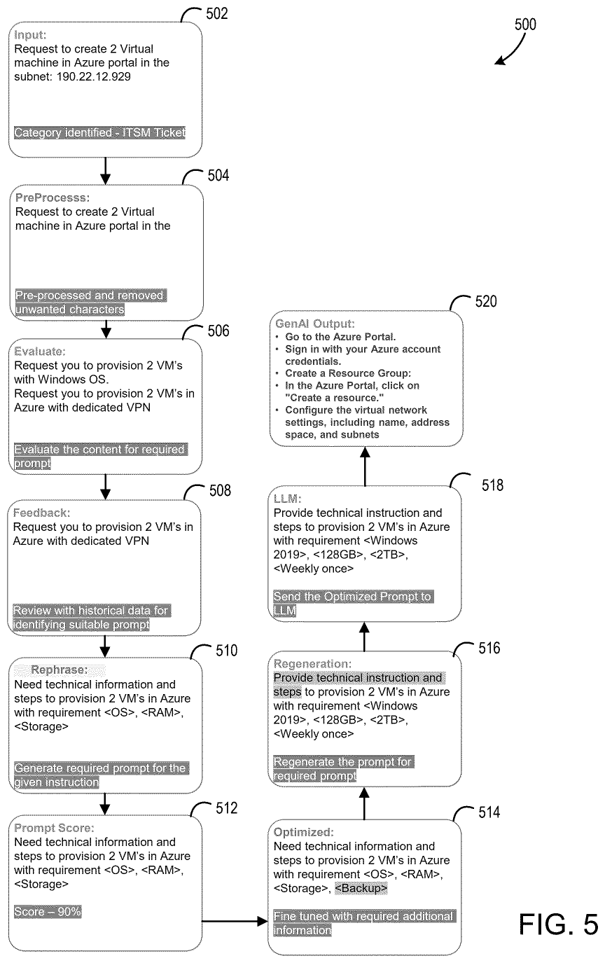

FIG. 5 illustrates an example 500 of prompt optimization for ITSM, for example, according to the process 300 of FIG. 3. Block 502 illustrates an example of a user prompt that is received and categorized as discussed, for example, with respect to blocks 302 and 304, respectively, of FIG. 3. In the example 500, the user prompt is categorized into ITSM.

In the example 500, block 504 illustrates an example of a preprocessed user prompt as discussed, for example, with respect to block 306 of FIG. 3. In the example 500, the preprocessed user prompt excludes information deemed irrelevant to the category and/or prompt, such as a subnet.

In the example 500, block 506 illustrates an example evaluation of the preprocessed user prompt by the evaluation engine 270, for example, as discussed relative to block 308 of FIG. 3. For illustrative purposes, the block 506 illustrates retrieval of two historical prompts.

In the example 500, block 508 illustrates an example of identifying a historical prompt that previously produced an accurate response as discussed, for example, with respect to block 310 of FIG. 3.

In the example 500, block 510 illustrates an example of a rephrased user prompt as discussed, for example, with respect to block 312 of FIG. 3.

In the example 500, block 512 illustrates an example scoring of the rephrased user prompt as discussed, for example, with respect to block 314 of FIG. 3.

In the example 500, block 514 illustrates an example of an optimized prompt as discussed, for example, with respect to block 316 of FIG. 3

In the example 500, block 516 illustrates an example of a regenerated optimized prompt as discussed, for example, with respect to block 320 of FIG. 3. In certain aspects, the regenerated optimized prompt can follow user interaction as discussed, for example, relative to block 318 of FIG. 3.

In the example 500, block 518 illustrates an example of a final prompt being provided to an LLM as discussed, for example, with respect to block 322 of FIG. 3.

In the example 500, block 520 illustrates an example of an output from the LLM as discussed, for example, with respect to blocks 324 and 326 of FIG. 3.

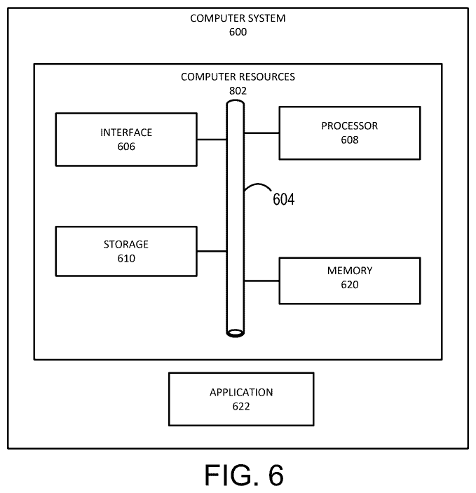

FIG. 6 illustrates an example of a computer system 600. In some cases, the computer system 600 can be representative, for example, of any of the tenant systems 110 or components thereof, the user systems 160, and/or the data processing system 140 or components thereof. The computer system 600 includes an application 622 operable to execute on computer resources 602. In particular embodiments, the computer system 600 may perform one or more actions described or illustrated herein. In particular embodiments, one or more computer systems may provide functionality described or illustrated herein. In particular embodiments, encoded software running on one or more computer systems may perform one or more actions described or illustrated herein or provide functionality described or illustrated herein.

The components of the computer system 600 may include any suitable physical form, configuration, number, type and/or layout. As an example, and not by way of limitation, the computer system 600 may include an embedded computer system, a system-on-chip (SOC), a single-board computer system (SBC) (such as, for example, a computer-on-module (COM) or system-on-module (SOM)), a desktop computer system, a laptop or notebook computer system, an interactive kiosk, a mainframe, a mesh of computer systems, a mobile telephone, a personal digital assistant (PDA), a wearable or body-borne computer, a server, or a combination of two or more of these. Where appropriate, the computer system 600 may include one or more computer systems; be unitary or distributed; span multiple locations; span multiple machines; or reside in a cloud, which may include one or more cloud components in one or more networks.

In the depicted embodiment, the computer system 600 includes a processor 608, memory 620, storage 610, interface 606 and bus 604. Although a particular computer system is depicted having a particular number of particular components in a particular arrangement, this disclosure contemplates any suitable computer system having any suitable number of any suitable components in any suitable arrangement.

Processor 608 may be a microprocessor, controller, or any other suitable computing device, resource, or combination of hardware, software and/or encoded logic operable to execute, either alone or in conjunction with other components, (e.g., memory 620), the application 622. Such functionality may include providing various features discussed herein. In particular embodiments, processor 608 may include hardware for executing instructions, such as those making up the application 622. As an example, and not by way of limitation, to execute instructions, processor 608 may retrieve (or fetch) instructions from an internal register, an internal cache, memory 620, or storage 610; decode and execute them; and then write one or more results to an internal register, an internal cache, memory 620, or storage 610.

In particular embodiments, processor 608 may include one or more internal caches for data, instructions, or addresses. This disclosure contemplates processor 608 including any suitable number of any suitable internal caches, where appropriate. As an example, and not by way of limitation, processor 608 may include one or more instruction caches, one or more data caches and one or more translation lookaside buffers (TLBs). Instructions in the instruction caches may be copies of instructions in memory 620 or storage 610 and the instruction caches may speed up retrieval of those instructions by processor 608. Data in the data caches may be copies of data in memory 620 or storage 610 for instructions executing at processor 608 to operate on; the results of previous instructions executed at processor 608 for access by subsequent instructions executing at processor 608, or for writing to memory 620, or storage 610; or other suitable data. The data caches may speed up read or write operations by processor 608. The TLBs may speed up virtual-address translations for processor 608. In particular embodiments, processor 608 may include one or more internal registers for data, instructions, or addresses. Depending on the embodiment, processor 608 may include any suitable number of any suitable internal registers, where appropriate. Where appropriate, processor 608 may include one or more arithmetic logic units (ALUs); be a multi-core processor; include one or more processors 608; or any other suitable processor.

Memory 620 may be any form of volatile or non-volatile memory including, without limitation, magnetic media, optical media, random access memory (RAM), read-only memory (ROM), flash memory, removable media, or any other suitable local or remote memory component or components. In particular embodiments, memory 620 may include random access memory (RAM). This RAM may be volatile memory, where appropriate. Where appropriate, this RAM may be dynamic RAM (DRAM) or static RAM (SRAM). Moreover, where appropriate, this RAM may be single-ported or multi-ported RAM, or any other suitable type of RAM or memory. Memory 620 may include one or more memories 620, where appropriate. Memory 620 may store any suitable data or information utilized by the computer system 600, including software embedded in a computer readable medium and/or encoded logic incorporated in hardware or otherwise stored (e.g., firmware). In particular embodiments, memory 620 may include main memory for storing instructions for processor 608 to execute or data for processor 608 to operate on. In particular embodiments, one or more memory management units (MMUs) may reside between processor 608 and memory 620 and facilitate accesses to memory 620 requested by processor 608.

As an example, and not by way of limitation, the computer system 600 may load instructions from storage 610 or another source (such as, for example, another computer system) to memory 620. Processor 608 may then load the instructions from memory 620 to an internal register or internal cache. To execute the instructions, processor 608 may retrieve the instructions from the internal register or internal cache and decode them. During or after execution of the instructions, processor 608 may write one or more results (which may be intermediate or final results) to the internal register or internal cache. Processor 608 may then write one or more of those results to memory 620. In particular embodiments, processor 608 may execute only instructions in one or more internal registers or internal caches or in memory 620 (as opposed to storage 610 or elsewhere) and may operate only on data in one or more internal registers or internal caches or in memory 620 (as opposed to storage 610 or elsewhere).

In particular embodiments, storage 610 may include mass storage for data or instructions. As an example, and not by way of limitation, storage 610 may include a hard disk drive (HDD), a floppy disk drive, flash memory, an optical disc, a magneto-optical disc, magnetic tape, or a Universal Serial Bus (USB) drive or a combination of two or more of these. Storage 610 may include removable or non-removable (or fixed) media, where appropriate. Storage 610 may be internal or external to the computer system 600, where appropriate. In particular embodiments, storage 610 may be non-volatile, solid-state memory. In particular embodiments, storage 610 may include read-only memory (ROM). Where appropriate, this ROM may be mask-programmed ROM, programmable ROM (PROM), erasable PROM (EPROM), electrically erasable PROM (EEPROM), electrically alterable ROM (EAROM), or flash memory or a combination of two or more of these. Storage 610 may take any suitable physical form and may include any suitable number or type of storage. Storage 610 may include one or more storage control units facilitating communication between processor 608 and storage 610, where appropriate.

In particular embodiments, interface 606 may include hardware, encoded software, or both providing one or more interfaces for communication (such as, for example, packet-based communication) among any networks, any network devices and/or any other computer systems. As an example, and not by way of limitation, communication interface 606 may include a network interface controller (NIC) or network adapter for communicating with an Ethernet or other wire-based network and/or a wireless NIC (WNIC) or wireless adapter for communicating with a wireless network.

Depending on the embodiment, interface 606 may be any type of interface suitable for any type of network for which computer system 600 is used. As an example, and not by way of limitation, computer system 600 can include (or communicate with) an ad-hoc network, a personal area network (PAN), a local area network (LAN), a wide area network (WAN), a metropolitan area network (MAN), or one or more portions of the Internet or a combination of two or more of these. One or more portions of one or more of these networks may be wired or wireless. As an example, computer system 600 can include (or communicate with) a wireless PAN (WPAN) (such as, for example, a BLUETOOTH WPAN), a WI-FI network, a WI-MAX network, an LTE network, an LTE-A network, a cellular telephone network (such as, for example, a Global System for Mobile Communications (GSM) network), or any other suitable wireless network or a combination of two or more of these. The computer system 600 may include any suitable interface 606 for any one or more of these networks, where appropriate.

In some embodiments, interface 606 may include one or more interfaces for one or more I/O devices. One or more of these I/O devices may enable communication between a person and the computer system 600. As an example, and not by way of limitation, an I/O device may include a keyboard, keypad, microphone, monitor, mouse, printer, scanner, speaker, still camera, stylus, tablet, touchscreen, trackball, video camera, another suitable I/O device or a combination of two or more of these. An I/O device may include one or more sensors. Particular embodiments may include any suitable type and/or number of I/O devices and any suitable type and/or number of interfaces 606 for them. Where appropriate, interface 606 may include one or more drivers enabling processor 608 to drive one or more of these I/O devices. Interface 606 may include one or more interfaces 606, where appropriate.

Bus 604 may include any combination of hardware, software embedded in a computer readable medium and/or encoded logic incorporated in hardware or otherwise stored (e.g., firmware) to couple components of the computer system 600 to each other. As an example, and not by way of limitation, bus 604 may include an Accelerated Graphics Port (AGP) or other graphics bus, an Enhanced Industry Standard Architecture (EISA) bus, a front-side bus (FSB), a HYPERTRANSPORT (HT) interconnect, an Industry Standard Architecture (ISA) bus, an INFINIBAND interconnect, a low-pin-count (LPC) bus, a memory bus, a Micro Channel Architecture (MCA) bus, a Peripheral Component Interconnect (PCI) bus, a PCI-Express (PCI-X) bus, a serial advanced technology attachment (SATA) bus, a Video Electronics Standards Association local (VLB) bus, or any other suitable bus or a combination of two or more of these. Bus 604 may include any number, type and/or configuration of buses 604, where appropriate. In particular embodiments, one or more buses 604 (which may each include an address bus and a data bus) may couple processor 608 to memory 620. Bus 604 may include one or more memory buses.

Herein, reference to a computer-readable storage medium encompasses one or more tangible computer-readable storage media possessing structures. As an example, and not by way of limitation, a computer-readable storage medium may include a semiconductor-based or other integrated circuit (IC) (such, as for example, a field-programmable gate array (FPGA) or an application-specific IC (ASIC)), a hard disk, an HDD, a hybrid hard drive (HHD), an optical disc, an optical disc drive (ODD), a magneto-optical disc, a magneto-optical drive, a floppy disk, a floppy disk drive (FDD), magnetic tape, a holographic storage medium, a solid-state drive (SSD), a RAM-drive, a SECURE DIGITAL card, a SECURE DIGITAL drive, a flash memory card, a flash memory drive, or any other suitable tangible computer-readable storage medium or a combination of two or more of these, where appropriate.

Particular embodiments may include one or more computer-readable storage media implementing any suitable storage. In particular embodiments, a computer-readable storage medium implements one or more portions of processor 608 (such as, for example, one or more internal registers or caches), one or more portions of memory 620, one or more portions of storage 610, or a combination of these, where appropriate. In particular embodiments, a computer-readable storage medium implements RAM or ROM. In particular embodiments, a computer-readable storage medium implements volatile or persistent memory. In particular embodiments, one or more computer-readable storage media embody encoded software.

Herein, reference to encoded software may encompass one or more applications, bytecode, one or more computer programs, one or more executables, one or more instructions, logic, machine code, one or more scripts, or source code, and vice versa, where appropriate, that have been stored or encoded in a computer-readable storage medium. In particular embodiments, encoded software includes one or more application programming interfaces (APIs) stored or encoded in a computer-readable storage medium. Particular embodiments may use any suitable encoded software written or otherwise expressed in any suitable programming language or combination of programming languages stored or encoded in any suitable type or number of computer-readable storage media. In particular embodiments, encoded software may be expressed as source code or object code. In particular embodiments, encoded software is expressed in a higher-level programming language, such as, for example, C, Perl, or a suitable extension thereof. In particular embodiments, encoded software is expressed in a lower-level programming language, such as assembly language (or machine code). In particular embodiments, encoded software is expressed in JAVA. In particular embodiments, encoded software is expressed in Hyper Text Markup Language (HTML), Extensible Markup Language (XML), or other suitable markup language. The foregoing description of embodiments of the disclosure has been presented for purposes of illustration and description. It is not intended to be exhaustive or to limit the disclosure to the precise form disclosed, and modifications and variations are possible in light of the above teachings or may be acquired from practice of the disclosure. The embodiments were chosen and described in order to explain the principals of the disclosure and its practical application to enable one skilled in the art to utilize the disclosure in various embodiments and with various modifications as are suited to the particular use contemplated. Other substitutions, modifications, changes and omissions may be made in the design, operating conditions and arrangement of the embodiments without departing from the scope of the present disclosure. Such modifications and combinations of the illustrative embodiments as well as other embodiments will be apparent to persons skilled in the art upon reference to the description. It is, therefore, intended that the appended claims encompass any such modifications or embodiments.

Depending on the embodiment, certain acts, events, or functions of any of the algorithms described herein can be performed in a different sequence, can be added, merged, or left out altogether (e.g., not all described acts or events are necessary for the practice of the algorithms). Moreover, in certain embodiments, acts or events can be performed concurrently, e.g., through multi-threaded processing, interrupt processing, or multiple processors or processor cores or on other parallel architectures, rather than sequentially. Although certain computer-implemented tasks are described as being performed by a particular entity, other embodiments are possible in which these tasks are performed by a different entity.

Conditional language used herein, such as, among others, “can,” “might,” “may,” “e.g.,” and the like, unless specifically stated otherwise, or otherwise understood within the context as used, is generally intended to convey that certain embodiments include, while other embodiments do not include, certain features, elements and/or states. Thus, such conditional language is not generally intended to imply that features, elements and/or states are in any way required for one or more embodiments or that one or more embodiments necessarily include logic for deciding, with or without author input or prompting, whether these features, elements and/or states are included or are to be performed in any particular embodiment.

While the above detailed description has shown, described, and pointed out novel features as applied to various embodiments, it will be understood that various omissions, substitutions, and changes in the form and details of the devices or algorithms illustrated can be made without departing from the spirit of the disclosure. As will be recognized, the processes described herein can be embodied within a form that does not provide all of the features and benefits set forth herein, as some features can be used or practiced separately from others. The scope of protection is defined by the appended claims rather than by the foregoing description. All changes which come within the meaning and range of equivalency of the claims are to be embraced within their scope.

1. A method of optimizing utilization of large language models (LLMs), the method comprising, by a computer system:
receiving a first prompt for a LLM;
categorizing the first prompt into a category based on a topic modeling algorithm;
processing the first prompt to remove information determined to be irrelevant to the category;
retrieving one or more historical prompts for the LLM based on a determination that the one or more historical prompts are similar to the first prompt;
identifying, based on a feedback model, at least one historical prompt of the one or more historical prompts as producing an accurate response from the LLM;
generating a final prompt for the LLM based on the at least one historical prompt; and
providing the final prompt to the LLM.

2. The method of claim 1, further comprising rephrasing the first prompt based on the at least one historical prompt, wherein the final prompt for the LLM is generated based on the rephrased first prompt.

3. The method of claim 1, further comprising:
rephrasing the first prompt based on the at least one historical prompt, wherein the rephrasing comprises inserting one or more placeholders for additional information;
generating a second prompt based on the at least one historical prompt, the second prompt comprising the one or more placeholders for additional information; and
interacting with a user to receive the additional information, wherein the generation of the final prompt comprises regenerating the second prompt to include the received additional information in place of the one or more placeholders.

4. The method of claim 3, wherein the rephrasing further comprises applying at least one of few-shot learning or prompt tuning to yield at least one of the one or more placeholders for additional information.

5. The method of claim 3, wherein the rephrasing comprises:
rephrasing the user prompt based on a first historical prompt of the plurality of historical prompts to yield a first rephrased user prompt; and
rephrasing the user prompt based on a second historical prompt of the plurality of historical prompts to yield a second rephrased user prompt,
wherein the generating the second prompt comprises selecting the first rephrased user prompt or the second rephrased user prompt based on a scoring relative to the feedback model.

6. The method of claim 1, wherein:
the categorizing is performed via a first software engine configured for category selection;
the processing is performed via a second software engine configured for prompt preprocessing; and
the retrieving and the identifying are performed via a third software engine configured for evaluating prompts relative to the plurality of historical prompts.

7. The method of claim 1, wherein the first prompt is input by a human user.

8. The method of claim 1, wherein the first prompt is input by a robotic user.

9. The method of claim 1, further comprising receiving an output from the LLM responsive to the providing the final prompt.

10. The method of claim 9, further comprising providing information related to the output to a user associated with the first prompt.

11. A system comprising a processor and memory, wherein the processor and memory in combination are operable to implement a method of optimizing utilization of large language models (LLMs), the method comprising:
receiving a first prompt for a LLM;
categorizing the first prompt into a category based on a topic modeling algorithm;
processing the first prompt to remove information determined to be irrelevant to the category;
retrieving one or more historical prompts for the LLM based on a determination that the one or more historical prompts are similar to the first prompt;
identifying, based on a feedback model, at least one historical prompt of the one or more historical prompts as producing an accurate response from the LLM;
generating a final prompt for the LLM based on the at least one historical prompt; and
providing the final prompt to the LLM.

12. The system of claim 11, the method further comprising rephrasing the first prompt based on the at least one historical prompt, wherein the final prompt for the LLM is generated based on the rephrased first prompt.

13. The system of claim 11, the method further comprising:
rephrasing the first prompt based on the at least one historical prompt, wherein the rephrasing comprises inserting one or more placeholders for additional information;
generating a second prompt based on the at least one historical prompt, the second prompt comprising the one or more placeholders for additional information; and
interacting with a user to receive the additional information, wherein the generation of the final prompt comprises regenerating the second prompt to include the received additional information in place of the one or more placeholders.

14. The system of claim 13, wherein the rephrasing further comprises applying at least one of few-shot learning or prompt tuning to yield at least one of the one or more placeholders for additional information.

15. The system of claim 13, wherein the rephrasing comprises:
rephrasing the user prompt based on a first historical prompt of the plurality of historical prompts to yield a first rephrased user prompt; and
rephrasing the user prompt based on a second historical prompt of the plurality of historical prompts to yield a second rephrased user prompt,
wherein the generating the second prompt comprises selecting the first rephrased user prompt or the second rephrased user prompt based on a scoring relative to the feedback model.

16. The system of claim 11, wherein:
the categorizing is performed via a first software engine configured for category selection;
the processing is performed via a second software engine configured for prompt preprocessing; and
the retrieving and the identifying are performed via a third software engine configured for evaluating prompts relative to the plurality of historical prompts.

17. The system of claim 11, wherein the first prompt is input by at least one of a human user or a robotic user.

18. The system of claim 11, the method further comprising receiving an output from the LLM responsive to the providing the final prompt.

19. The system of claim 18, the method further comprising providing information related to the output to a user associated with the first prompt.

20. A computer-program product comprising a non-transitory computer-usable medium having computer-readable program code embodied therein, the computer-readable program code adapted to be executed to implement a method of optimizing utilization of large language models (LLMs), the method comprising:
receiving a first prompt for a LLM;
categorizing the first prompt into a category based on a topic modeling algorithm;
processing the first prompt to remove information determined to be irrelevant to the category;
retrieving one or more historical prompts for the LLM based on a determination that the one or more historical prompts are similar to the first prompt;
identifying, based on a feedback model, at least one historical prompt of the one or more historical prompts as producing an accurate response from the LLM;
generating a final prompt for the LLM based on the at least one historical prompt; and
providing the final prompt to the LLM.
